(19) United States
(12) Patent Application Publication
(10) Pub. No.: US 2007/0291631 A1
(43) Pub. Date: Dec. 20, 2007

(54) Method of marking graphic or similar patterns on the recorded face of an optical data recording medium and optical data recording medium implementing said method

(76) Inventor: Francois Menne, Bussy Saint Georges (FR)

Correspondence Address: GOTTLIEB RACKMAN & REISMAN PC, 270 MADISON AVENUE, 8TH FLOOR, NEW YORK, NY, 10016-0601, US

(21) Appl. No.: 11/114,685

(22) Filed: Apr. 26, 2005

(30) Foreign Application Priority Data
Apr. 26, 2004 (FR) 04 50777

(51) Int. Cl. G11B 5/84; B41M 99/00

(52) U.S. Cl. 369/286; 427/145

(57) ABSTRACT

The invention concerns a method of marking graphic patterns on the face (20), called usable, bearing data (2000, 2001) of an optical medium (2) comprising the production of said medium (200) of transparent material, the selective deposit of a first material (203) with reflective property on the usable face over an area in correlation with the graphic patterns, the uniform deposit of a second material (201) with reflective property and the deposit of a layer of protective varnish (202). The first (203) and second (201) materials have different colors making it possible to discern, by contrast effect, the areas covered by the first layer from the adjacent uncovered areas, when the usable face (20) is lighted by a light source (la).

The invention also concerns optical media (2), CD or DVD, produced by this method.

The invention concerns a method of marking graphic or similar patterns on the recorded face of an optical data recording medium.

Within the scope of the invention, “recorded face” is understood to mean the face that will be considered the “usable” face of an optical data recording medium, that is, the face that is read and/or recorded by a laser beam, or the face “exposed” to this beam.

Moreover, the term “optical data recording medium” should be taken in its most general sense. For example, it includes CD (for Compact Disc) or DVD (for Digital Versatile Disc). Within these two categories there are numerous types: Audio CD, CD-ROM (for Read-Only Memory), CD-R (disk, recordable once), CD-RW (re-recordable disk), Audio DVD, DVD ROM, DVD+R (DVD disk, recordable once), DVD+RW (re-recordable DVD), etc. Furthermore, there can be different DVD technologies: DVD 5, DVD 10, DVD 9, DVD 18, etc.

The information itself can represent any type of information, but generally multimedia information: digital data and/or music and/or image and/or video, etc.

Finally, the terms “graphic patterns” should also be understood, within the scope of the invention, in their most general sense: graphic symbols, designs, logos, labels, simple texts, photos, etc.

All these types of media and technologies are well known to a person skilled in the art, and it is of no use to review their detailed characteristics. For the most part, these characteristics are covered by conventions or standards.

More specifically, a commercial pre-recorded CD-type optical medium—Audio CD or CD-ROM—will be considered, although this does not limit the scope of the invention in any way.

It is useful briefly to review the principal characteristics of an optical disk of this type.

It is composed of a circular “blank disk” forming the base medium, made of a transparent synthetic material. In the case of an Audio CD or a CD-ROM, one of the faces is pressed for “engraving” information on it. In practice, the information is composed of a succession of microreliefs, “pits” and “lands” that are very small in size, on the order of a micrometer. This information is distributed along concentric circular tracks.

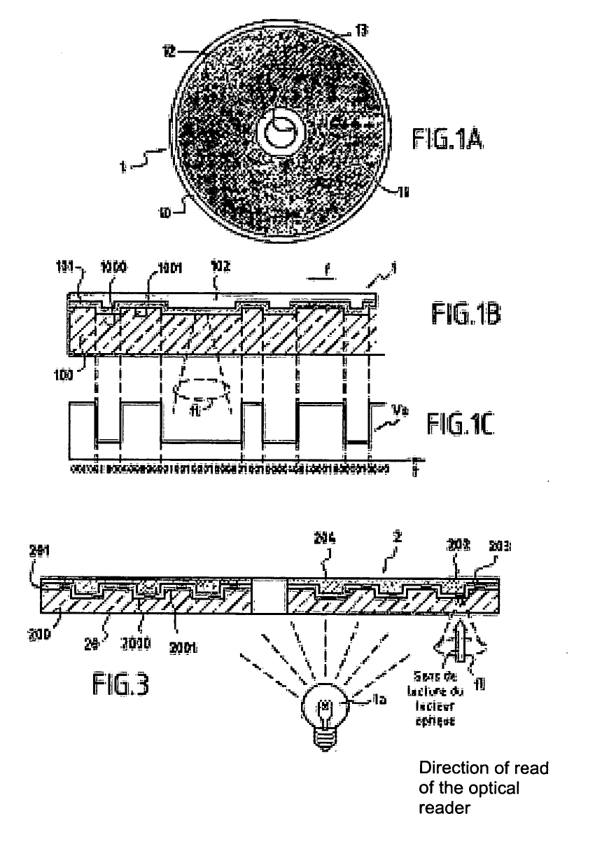

FIGS. 1A and 1B, appended to this description, represent an optical disk 1, viewed from the bottom and in cross section, respectively.

Indeed, FIG. 1A is a view that will arbitrarily be called a bottom view, because it shows the lower face exposed to the read laser beam (FIG. 1B: fl).

The disk 1 has three ring-shaped areas, 10 to 12, around a circular central orifice 13 used to drive it in rotation by an appropriate mechanism (not shown).

The central ring-shaped area, 11, with the largest surface area, is the portion on which the data are engraved. There are two areas without information, a peripheral ring 10 and a central ring 12.

In reality, it is well known that additional information can be written to these areas in order to characterize the medium.

More specifically, the most current CD-ROMs have an outside diameter of 120 mm, and the central orifice 13 has a diameter of 15 mm.

FIG. 1B illustrates the disk 1 of FIG. 1 in partial cross section. It is composed of three principal superimposed layers: one medium layer 100 of transparent synthetic material, with typical thickness of 1.2 mm, a layer of reflective material 101, a priori of aluminum and with typical thickness of 0.1 μm, and a protective layer 102 of synthetic material, with typical thickness of 200 μm.

Shown in this FIG. 1B is a succession of microreliefs composed of “pits” 1000 and “lands” 1001, distributed along tracks (not explicitly shown) and representing recorded data. It should be understood that the data recording step, by pressing, is done before the steps of covering by the reflective and protective layers, 101 and 102.

To read the recorded data, a laser beam fl is focused on the tracks of data, through the transparent layer of the medium 100. After reflection/diffraction on the sequence of “pits” 1001 [sic: 1000] and “lands” 1000 [sic: 1001], the laser beam fl is sensed by photo-detectors associated with electronic circuits (not shown) which convert the optical signals into a succession of electrical signals.

Different detection technologies can be used. In FIG. 1C it is assumed that the transitions between “pits” 1001 [sic: 1000] and “lands” 1000 [sic: 1001] are detected, the lands having lengths that vary as a function of the recorded information. A sequence of rectangular signals is thus obtained, the rising and descending fronts of which are synchronized with the detection of the said transitions. Shown in this same figure is a time axis t. Assuming that the disk 1 is moved along the direction of the arrow f (FIG. 1B), and using the clock signals generated by conventional electronic circuits (not shown), a series of “0” and “1” is obtained, representing the binary information recorded on the disk 1, in the area 11 (FIG. 1A).

Because of the configuration that has just been described, the data recorded on the disk 1 being read, by the focused laser beam fl, through the transparent base medium 100, it is not possible to print or apply symbols on the face exposed to the read laser beam fl, and more generally the read and/or write beam for (re)-writable media. These symbols would interfere with the laser beam fl and would risk seriously disturbing the reading and/or writing of data.

Also, it is customary when there is a need to print or affix symbols thereto, such as design, title of the disk, commercial information, photos and various designs, etc., to use the opposite face, that is, the surface of the protective layer 102.

When the disks are to be engraved by means of a write laser, for example those of the CD-R or CD-RW type, self-adhesive labels are available in the dimensions of the disk with a pre-punched central orifice, which can be adhered to this face after being printed with an appropriate printer. Also available are printers that can print directly on this face.

In all these cases, the printing or affixing of symbols is still limited to the unexposed face.

The invention seeks to overcome the disadvantages of methods of the known art, some of which have just been reviewed.

A purpose of the invention is a method, presented in three principal variations, allowing graphic or similar patterns to be printed on the face of an optical data recording medium exposed to a read and/or write laser beam, and in the usable area of said face, that is, the area having said recorded data.

To do this, according to a first important characteristic, the method according to the invention includes at least one step consisting of selectively depositing an additional reflective layer that has physical characteristics different from those of the conventional principal layer of material with reflectivity.

In the first and second forms of embodiment, there are two layers of reflective materials of different colors, such as gold and aluminum. In a third form of embodiment, a varnish layer with reflective properties is used as well as a metallization layer, or a reflective, but semi-transparent, layer called HRI (High Reflection Index).

The “printed” pattern can then be discerned from the adjacent areas, that is, “read,” by contrast effect, without interfering with the read and/or write laser beam of the “usable” data, that is, those recorded on the disk.

The method according to the invention therefore allows a “printed” pattern to be produced, sealed inside the layers of materials with reflective property. This pattern is thus made impregnable, but without creating excessive thickness of the surface. It is therefore possible to obtain a marking pattern of an optical recording medium such as CD or DVD that makes it possible to authenticate its provenance with certainty. Consequently the method according to the invention offers a tool for effectively fighting piracy.

Moreover, the pattern created according to the method of the invention is visible either by direct observation of the face of the medium bearing the information (side of the layer of partially reflective material), or by observation of the opposite face of the medium, transparent, the layers of reflective materials, preferably not being opaque. The pattern thus appears as a watermark. This contributes an additional degree of authentication conferred by the pattern itself.

Advantageously, the method according to the invention makes it possible to produce a pattern even on an optical data recording medium having two read faces such as a high-capacity DVD. In this way it is now possible to have exterior markings, which could not be done without reducing the surface reserved for information.

Except for this additional layer, the disk obtained is a conventional type, with configuration according to the known art.

It is also possible, as in the known art, to print (by serigraphy or any other conventional method) an additional design on the upper face of the protective layer, or to affix a self-adhesive label there.

This printing can be done so that the printed pattern is combined by transparency with the outer print when the printed face of the medium is viewed, in order to form a new pattern (also known by the term “see-thru”).

The method according to the invention remains therefore completely compatible with the technologies that implement the technique, and the final product obtained also remains completely compatible with the conventions and standards in effect in this area.

A principal object of the invention, therefore, is a method of marking at least one graphic or similar pattern on the face bearing the information, called the usable surface, and exposed to a laser beam to read an optical medium, said method comprising a step of producing said medium of transparent synthetic material, characterized in that it comprises at least the following steps:
the deposit of a first layer of a first material with reflective property selectively covering said usable face over an area in correlation with said graphic pattern;
the deposit of a second layer of a second material with reflective property uniformly covering said first layer of first material with reflective property and said usable face;
the deposit of a layer of protective material on said second layer of material with reflective property;
   and in that said first and second materials with reflective property have different predetermined physical characteristics making it possible to discern, by contrast effect, areas of said usable face that are covered by said first layer from adjacent areas not covered by this layer, when said usable face is lighted by a specific light source.

An object of the invention is also an optical data recording medium obtained by said method.

The invention will now be described in more detail, with reference to the attached drawings in which:

FIGS. 1A and 1B illustrate diagrammatically an example of a CD-ROM type of disk, pre-recorded according to the known art, in bottom view and cross sectional view, respectively;

FIG. 1C illustrates an example of electrical signals read from such a disk;

FIG. 3 illustrates very diagrammatically an optical disk produced according to the method according to the invention; and

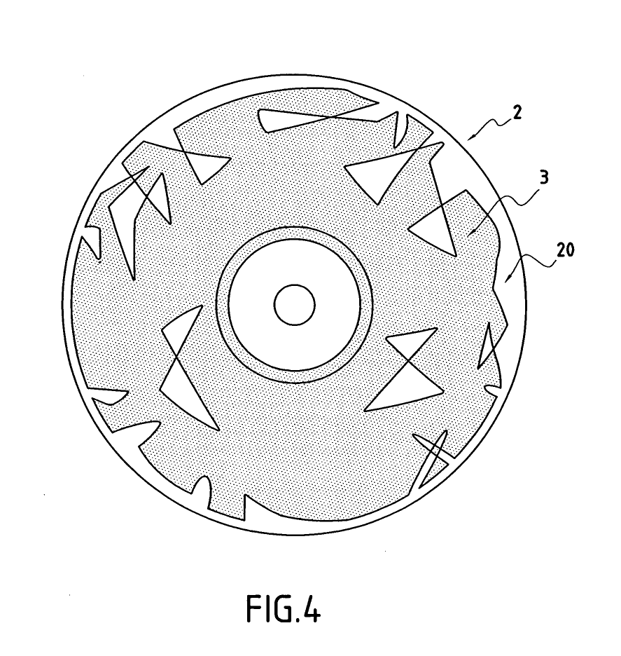

FIG. 4 illustrates diagrammatically the disk of FIG. 3, in bottom view, with a design on the recorded face.

The following, without in any way limiting the scope, is provided in the context of producing a pre-recorded disk such as a CD-ROM or Audio CD, that is, a commercial read-only disk on which multimedia digital data are recorded in a generic way.

A first form of embodiment of such a disk will now be described with reference to FIG. 3, which very diagrammatically illustrates this disk in cross section. The disk from now on will be referenced 2.

The principal steps of this first form of embodiment of the method according to the invention are as follows:
1. Manufacture of a blank disk to bear the data, by plastic injection, thermoforming or any other appropriate manufacturing process.
2. First metallization of the data-bearing surface, such as by depositing a uniform aluminum layer.
3. Deposit of a protective varnish layer comprising a selective mask for forming the pattern to be printed.
4. Selective demetallization of the unprinted areas (only the metallization areas protected by the varnish of the mask remain).
5. Second metallization, by a uniform metallic layer, of different color than the first metallization layer, particularly a gold layer.
6. Protection of the metalized surface by a protective varnish layer, curable by ultraviolet radiation.

As has been indicated, essentially the method according to the invention remains completely compatible with the technologies that implement the technique, and the final product obtained, the disk 2, also remains completely compatible with the conventions and standards in effect in this area.

Furthermore, steps 1, and 6 to 7 [sic] per se are similar, if not identical, to the equivalent steps required to produce a disk according to the known art.

The steps above will now be detailed.

In step 1 the data-bearing blank disk is manufactured, for example by injecting a synthetic material, particularly a polycarbonate, into an injection mold (not shown). In this mold, a matrix called “optical” makes it possible to “engrave” on the surface of this plastic blank disk 200, once it has cooled, digital data, customarily in the form of microreliefs composed of “pits” 2000 and “lands” 2001. This stage 1 of injecting plastic material is well known and is common to the known art. There is therefore no need to describe it further. The injection can be replaced by a thermoforming process or by any other appropriate method of manufacturing a blank disk of plastic material.

The first metallization, done during step 2, is performed by depositing an initially uniform layer 203 of aluminum or other similar metal. To do this, a known method called sputtering can be used.

More specifically, the thickness of the layer 203 is typically on the order of about ten nanometers.

This step 2 is the first step that is specific to the method according to the invention.

The printing of step 3, using a protective varnish selectively covering the layer 203, can be done by various well-known processes such as serigraphy, offset, pad printing, etc.

More specifically, the varnishes or resins used can be acrylic, nitrocellulosic, polyester, epoxy or polyurethane. It is essential that they be resistant to caustic soda [or] similar products that will be used in step 4.

Again to be more specific, the thickness of the resin layer is typically on the order of a few micrometers.

It is during this step 3 that the pattern to be printed on the face that will be “exposed” to the laser beam (FIG. 3: “direction of read of the optical reader”) is defined. Indeed, the configuration of the varnish layer is in correlation with that of the patterns to be printed on this face: graphics, logos, texts, etc. The deposit of the varnish layer is therefore selective, and this layer only covers predetermined areas of the face that will be called the upper face of the medium 200, more specifically of the first layer of metallization 203.

This step 3 is the second step specific to the method according to the invention.

The selective demetallization of step 4 is done by chemical attack. The product that can be used for this is particularly an alkaline pH solution such as caustic soda. The varnish used in step 3 must therefore be resistant to this product.

This step 4 is the third step specific to the method according to the invention.

A step 4 bis, cleaning, can advantageously be added to eliminate the remaining varnish layer in the metalized parts in order to minimize excessive thicknesses.

Step 5 consists of a second metallization 201. The material deposited on the first metallization layer 203 is a metallic material of a color different from that of the first metallization layer 203. [sic] In particular, gold can be used. To deposit the layer 201, the well-known procedure called sputtering can be used as before.

More specifically, the thickness of the layer 201 is typically on the order of about ten nanometers.

This layer 201 is in direct contact with the surface of the medium 200 and molds to the microreliefs, the “pits” 2000 and “lands” 2001, representing recorded data and acts as the reflective layer 101 (FIG. 1B) of disks of the known art.

Step 6, in common with the known art, consists of protecting the composite metallization (superimposed layers 203 and 201) by a layer of varnish 202, accomplished in a completely conventional way. To do this, materials of well-known types are used, applied by centrifuging on the upper surface of the disk 2 and cured by exposure to ultraviolet radiation.

More specifically, the thickness of the layer of varnish 202 is typically a few micrometers.

This step can be followed by a step also common to the known art, which consists of printing a design 204 on the surface of the final protective layer 202. A design can be printed in a conventional way in one or more colors using serigraphy, offset or pad printing methods. The inks used can be UV or other type.

More specifically, the thicknesses of the print layers are on the order of a few micrometers.

According to one of the most important characteristics of the method according to the invention, the pattern, graphic or similar, that is printed on the active face 20 of the disk 2, i.e., the face bearing the data, 2000-2001, can be discerned simply by exposing said face 20 to a source of “normal” light, symbolized by an incandescent lamp la (daylight, etc.) by the contrast effect with adjacent areas (non de-metalized) of the selective metallization layer 203 and the continuous metallization layer 201.

On the other hand, the metallization layer 203, underlying the layer 201, does not in any way disturb the reading of the data (reliefs 2000-2001) recorded on the usable surface 20 of the medium 200 by a laser beam (FIG. 1B: fl). Indeed, the composite layer 203-201 acts practically like a single, uniform layer since, at least, the reflective layer 201 covers the whole usable surface 20 of the disk 2, including in the de-metalized areas of the layer 203. This composite layer, by the effect of the above-mentioned reflection/refraction, allows the laser beam fl to follow the variations of the microreliefs (“pits” 2000 and “lands” 2001), and thus to read the recorded information.

FIG. 4 shows a bottom view of the disk 2 according to FIG. 3, in a bottom view [sic] (called the active face) with a pattern 3 printed on the recording face 20.

A second form of embodiment of the method of the method [sic] according to the invention will now be described.

The principal steps of this second form of embodiment are as follows:
1. Manufacture of a blank disk to carry the data, by plastic injection, thermoforming or any other appropriate manufacturing process.
2. Deposit by selective printing of a so-called “strippable” layer of varnish on the data-bearing face, forming a mask.
3. First metallization of the data-bearing surface by depositing a uniform reflective layer such as aluminum or gold.
4. “Stripping” the printed areas by removing the above-mentioned layer of varnish, resulting in the correlative disappearance of the metallization in these areas.
5. Second metallization, by means of a uniform metallic layer, of a different color than the first metallization layer.
6. Protection of the metalized surface by a protective layer of varnish, curable by ultraviolet radiation.
7. Printing a design on this surface. Obviously, this step is optional.

The steps set forth above will now be detailed.

Step 1 is in common with the first form of embodiment as well as with the known art, and there is therefore no need to describe it again.

Step 2 consists of the selective deposit of a layer of so-called “strippable” resin. This can be done, for example, by serigraphy, offset or pad printing.

More specifically, the resins that can be used can be silicone or acrylonitrile butadiene copolymer base, etc.

Also, more specifically, the thickness of the resin layer is on the order of a few micrometers.

The covered areas of the surface of the medium are in correlation with the pattern to be printed on the so-called active face, i.e., the data-bearing face.

This step 2 is the first step specific to the method according to the invention.

Step 3 consists of depositing a uniform metallization layer. This step is very similar to step 2 of the first form of embodiment. It therefore need not be described again in detail.

Step 3 is the second step specific to the method according to the invention.

Step 4 consists of stripping the varnish/first metallization composite layer in the printed areas, which results in the removal of the first metallization layer in these areas. This can be accomplished by chemical or mechanical action, particularly by brushing the strippable layer with suitable brushes.

This step 4 is the third step specific to the method according to the invention.

At the end of this step, only the areas of the first metallization layer that did not cover the areas of the strippable varnish layer are left. The configuration of these areas is in correlation with the shape of the pattern to be printed (FIG. 4: 3).

Step 5 consists of depositing a second metallization layer. It is also very similar to step 5 of the first form of embodiment, and it is therefore unnecessary to describe it again in detail. It only need be pointed out that, as in the first form of embodiment, the second metal should be of a different color than the first, transparent, semi-transparent or not.

More specifically, the thickness of the second metallization layer is typically on the order of about ten nanometers.

Also as before, the second metallization layer is in direct contact with the surface of the medium; said layer molds to the reliefs representative of the recorded information and acts as the conventional reflective layer 101 (FIG. 1B) of disks of the known art.

The subsequent steps, in common with the known art, can be strictly identical to the equivalent steps of the first form of embodiment, and there is therefore no need to describe them again in detail.

Upon completion of the printing step, the disk obtained is completely similar to the disk 2 of FIGS. 3 and 4.

As before, the pattern 3, graphic or similar, printed on the active face of the disk can be discerned simply by exposure of this active face to a source of “normal” light (daylight, etc.) by the contrast effect between the remaining areas of the first metallization layer and the uniform second metallization layer.

On the other hand, as before, the first metallization layer, underlying the second metallization layer, does not disturb in any way the reading of the data.

A third form of embodiment of the method according to the invention will now be described.

The principal steps of this third form of embodiment are as follows:
1. Manufacture of a blank disk to bear the data, by plastic injection, thermoforming or any other appropriate manufacturing process.
2. Deposit by selective printing of a layer of reflective material such as a reflective varnish on the data-bearing face.
3. Metallization of the data-bearing surface, by depositing a uniform layer such as aluminum or gold.
4. Protection of the surface by a layer of protective varnish, curable by ultraviolet radiation.
5. Printing a design on this surface.

The foregoing steps will now be set forth in detail.

Step 1 is in common with the first form of embodiment as well as the known art, and there is therefore no need to describe it again.

Step 2 consists of the selective deposit of a layer of reflective material such as varnish, resin. This can be done, for example, by serigraphy, offset or pad printing, etc.

More specifically, the resins that can be used, preferably curable by ultraviolet radiation, can be of the “conductive ink” type.

Again, to be more specific, the thickness of the resin layer is on the order of a few micrometers.

This step 2 is the first step specific to the method according to the invention, more particularly according to the third form of embodiment.

Steps 3 to 5 can be strictly identical to the corresponding steps of the first and second forms of embodiment, and there is therefore no need to describe them again in detail.

It will be noted that this third form of embodiment of the method according to the invention has fewer steps than the first two forms.

Upon completion of step 5, the disk obtained is similar to the disk 2 of FIGS. 3 and 4, with the exception that the first selective metallization layer is replaced by a layer of resin having reflective properties.

As before, the pattern, graphic or similar, printed on the active face of the disk, can be discerned simply by exposing this active face to a source of “normal” light (daylight, etc.) by the contrast effect of color between areas covered by the layer of reflective resin and the uniform metallization layer.

On the other hand, as before, the layer of reflective resin, underlying the metallization layer, does not disturb in any way the reading of data.

In the preceding description, it can easily be seen that the invention achieves its purposes.

In particular, it makes it possible to print indelibly various patterns, graphics or other things on the usable face of an optical data recording medium, that is, the face exposed to the read and/or write laser beam.

It should be clear, however, that the invention is not limited only to the examples of embodiment explicitly described, especially in relation to FIG. 3.

It is also not limited only to producing disks like Audio CD or CD-ROM. As has been mentioned, it is compatible with producing numerous other types of media, such as DVD, etc.

The numbered examples were only furnished to provide a more specific understanding and do not constitute any limitation whatever to the scope of the invention. They result from a technological choice available to a person skilled in the art.

Finally, the materials mentioned, which can be used within the scope of the invention, were only indicated by way of example and only result from a technological choice available to a person skilled in the art. As has been mentioned, and as an additional advantage, the method of the invention is compatible with the technologies used currently in the known art and the materials used for these technologies.

1. Method of marking at least one graphic or similar pattern on the face bearing the information, called the usable surface, and exposed to a laser beam to read an optical medium, said method comprising a step of producing said medium of transparent synthetic material, characterized in that it comprises at least the following steps:
the deposit of a first layer (203) of a first material with reflective property selectively covering said usable face (20) over an area in correlation with said graphic pattern;
the deposit of a second layer (201) of a second material with reflective property uniformly covering said first layer (203) of first material with reflective property and said usable face;
the deposit of a layer of protective material (202) on said second layer of material with reflective property;
and in that said first and second materials with reflective property have different predetermined physical characteristics making it possible to discern, by contrast effect, areas of said usable face (20) covered by said first layer (203) from adjacent areas not covered by this layer, by observing said usable face (20) when it is lighted by a specific light source (1a).

2. Method according to claim 1, characterized in that said first layer of a first material with reflective property is composed of a layer of a first metal and in that it is comprised of the following steps:
the deposit of a layer of protective varnish comprising a mask selectively covering said first layer (203) of said first metal in order to form said pattern;
the selective removal of said first layer (203) of said first metal in the areas not covered by said layer of varnish; and
the deposit of a uniform layer (201) of a second metal, in order to obtain said second layer of second material with reflective property.

3. Method according to claim 2, characterized in that said protective layer of varnish comprising a selective mask is eliminated before the deposit of the layer (201) of the second material with reflective property.

4. Method according to claim 1, characterized in that said first layer (203) of a first material with reflective property is composed of a layer of a first metal and in that it is comprised of the following steps:
the deposit of a layer of so-called strippable varnish comprising a mask selectively covering said usable surface (200) to form said pattern;
the uniform deposit. of a first layer of a first material with reflective property (203);
the removal of said layer of strippable varnish so as to selectively remove said layer (203) of first metal in the areas not covered by said layer of “strippable” varnish;
the cleaning of the surface thus obtained; and
the uniform deposit of a layer of a second metal (201), so as to obtain said second layer of second material with reflective property.

5. Method according to claim 1, characterized in that it is comprised of the following steps:
the deposit of a layer of reflective material such as a varnish selectively covering said data-bearing face in order to form said pattern, said varnish comprising the first material with reflective property; and
the deposit of a uniform layer of metal (201), so as to obtain said second layer of second material with reflective property.

6. Method according to claims 2, 3 or 4, characterized in that said first metal is aluminum and said second material is gold.

7. Method according to claim 5, characterized in that said material is aluminum or gold and in that said “strippable” varnish is silicone or acrylonitrile butadiene base.

8. Method according to any one of claims 1 to 5 or 7, characterized in that the deposit of said layers of varnish is performed by serigraphy, offset or pad printing.

9. Method according to claim 1, characterized in that said layer (202) of protective material is a varnish applied by centrifuging, followed by curing by exposure to ultraviolet radiation.

10. Method according to claim 1, characterized in that said different predetermined physical characteristics are different colors.

11. Optical data recording medium comprising a blank disk of transparent material recording data on at least one of its faces, called the usable face, characterized in that it has at least a first layer (203) of a first material with reflective property selectively covering said usable face over an area in correlation with said graphic pattern, a second layer (201) of a second material with reflective property uniformly covering said first layer (203) of first material with reflective property and said usable face of said medium (200), and a layer of protective material (202) covering said layer (201) of second material with reflective property, and in that said first and second materials with reflective property have different predetermined physical characteristics making it possible to discern, by contrast effect, areas of said usable face (20) covered by said first layer (203) from adjacent areas not covered by this layer, by observing said usable face (20) when it is lighted by a specific light source (la).

12. Optical data recording medium according to claim 11, characterized in that it has a “printed” pattern, sealed inside the layers of materials with reflective property, this pattern thus being made impregnable, but without creating excessive thickness of the surface and comprising an authentication marking pattern.
